(19) United States
(12) Patent Application Publication
(10) Pub. No.: US 2013/0074783 A1
(43) Pub. Date: Mar. 28, 2013

(54) LEASH SLACK CONTROL SYSTEM

(71) Applicant: Paul W. Chapin, Minneapolis, MN (US)

(72) Inventor: Paul W. Chapin, Minneapolis, MN (US)

(21) Appl. No.: 13/629,132

(22) Filed: Sep. 27, 2012

Related U.S. Application Data
(60) Provisional application No. 61/539,749, filed on Sep. 27, 2011.

(51) Int. Cl. A01K 27/00

(52) U.S. Cl. CPC A01K 27/004
USPC 119/796

(57) ABSTRACT

A leash system for controlling the slack in the leash to prevent the animal from becoming entangled in the leash. The leash system has a spool mounted wire controlling the effective length in the leash by forming a loop in the leash to absorb any slack. If the animal pulls away from the person and additional leash length is required, wire can be automatically played out from the spool so that the loop can be opened to provide the required slack. Similarly, the wire will automatically retract to reform the loop and absorb the slack the leash once the animal moves back toward the person such that the effective length of the leash remains relatively taut.

### RELATED APPLICATION

The present application claims the benefit of U.S. Provisional Application. No. 61/539,749, filed Sep. 27, 2011, which is incorporated herein by reference in its entirety.

### FIELD OF THE INVENTION

The present invention is generally directed to a leash system for controlling and adjusting the effective length of a fixed length leash. Specifically, the present invention is directed to a leash system that controls slack in a fixed length leash by forming excess portions of the leash into a loop or folds over the excess portion of the leash to passively adjust the effective length of the leash according to the relative position of the leashed animal.

### BACKGROUND OF THE INVENTION

Leashes are a common means of leading and restraining animals, in particular dogs, through unenclosed locations. In the most basic form, a leash is simply an elongated strap or cord having a handle at one end held by a person and connected to a collar or halter worn by the animal at the other end. The overall length of the strap or cord defines the maximum distance the animal can wander from the person holding the leash. When the animal is at the maximum distance from the person, the leash is pulled taut allowing the person to restrain or direct the animal by manipulating the handle end of the leash. However, when the animal is less than the maximum distance from the person, the leash is slack often causing a portion of the leash to hang near or below the animal's feet. The slack leash can cause the animal can trip over the leash or become tangled in the leash creating an inconvenience for the person and possibly injuring either the animal or the person. In addition, the slack leash can be dragged along the ground resulting in dirt and other contaminants being transferred to the leash and eventually to the animal.

Certain leashes are mounted on a spool that allow the leash to be played out to increase the effective length of the leash and rewind the leash back onto the spool to decrease the effective length of the leash. The spool can be spring-loaded to freely play out additional leash as required while automatically draw in any excess leash onto the spool thereby minimizing slack in the spool. The spool assembly typically can include a lock that can be manually engaged to lock the spool and fix the leash length at a desired effective length. However, the unlocked spool requires that the user pay careful attention to the behavior of the animal as the animal can potentially run further than the desired distance before the user can lock the spool to restrain the animal. In addition, the spool assembly typically requires a robust mechanical assembly able to lock the spool while the animal is moving quickly away from the user. The mechanical assembly significantly increases the weight and complexity of the spool leashes. In addition, the constant use of the lock as a brake for slowing and stopping the animal can place considerable strain on the brake, which can ultimately cause the brake to fail. Although, the spool can be pre-fixed at a particular effective length, the same drawbacks that apply to fixed length leashes would then apply. Specifically, the animal's movements can create slack in the now fixed effective length of the leash causing the animal to trip over or become entangled in the leash. As a wire is often used in spooling leashes instead of flat straps to permit easy winding and unwinding from the spool, the spooling leashes are particularly susceptible to entangling the animal. Other leashes, such as disclosed in US Patent Application Publication No. 2010/0037833, comprise an elastic, stretching, stretchable spring or other extendable element that extends or contracts to change the effective length of the leash. If the animal moves away from the person, the animal pulls on the leash extending the leash to increase the effective length of the leash. When the animal moves back toward the person the leash contracts reducing the effective length of the leash to prevent the animal from tripping over the leash. The inherent drawback of the extendable leashes is the inability to fix the maximum distance. Although the limited elasticity of the leash material will ultimately prevent the leash from being extend beyond a specific length, the user cannot readily determine the maximum effective length or shorten the maximum length. A related drawback is that if the animal does become ensnared in the extending leash, the elasticity of the leash could make extracting the animal even more difficult.

Although leashes are commonly used, certain aspects of the leashes still require improvement. Specifically, regulating the slack in the leash to avoid tripping the animal or tangling the animal in the leash still requires substantial improvement.

### SUMMARY OF THE INVENTION

The present invention is directed to a leash system that passively controls the slack in a fixed length leash by collapsing the slack portion of the leash into a loop or folding the slack portion upon itself to shorten the effective length of the leash. For the purpose of this description, the effective length of the leash is the length of leash extending between the person and the animal that is not contained within the loop. The leash system passively controls the slack by automatically adjusting the effective length of the leash in response to the tension applied to the leash by the movement of the animal without active intervention by the user.

The leash system, according to an embodiment of the present invention, generally comprises a spring-loaded spool positioned at a first position on the leash and a wire wound on the spool and attached at one end to a second position on the leash. The wire can include, but is not limited to a round wire, a cable, a braided wire or a flat wire. The spring-loaded spool automatically winds the wire on to the spool when no tension or tension below a predetermined threshold is applied to the leash, such as when the animal is close to the holder of the leash, to pull the first and second positions together to form a loop or fold the leash to shorten the overall effective length of the leash and eliminate slack in the leash. If the animal pulls away from the person and additional leash length is required, the spool mounted wire can be automatically played out from the spool to open the loop or folds thereby increasing the effective length of the leash. The spring can be tensioned such that the spool retains the loop or folds until the animal's movements apply sufficient tension to the wire at which point wire is pulled from the spool passively without any action by the user. Similarly, the spring will operate the spool to rewind the wire back onto the spool without any action by the user once the tension is removed. The leash system allows for fluid adjustment of the effective length of the leash without any direct intervention by the user.

In one aspect, the second position on the leash can be positioned proximate to the center of the leash or at location along the leash to define a portion of the leash that is not folded into a loop or accordion shape when the wire is wound onto the spool. The portion of the leash not folded by the leash system can correspond to the ordinary distance between the user's hands and the animal's collar or muzzle when the animal and user are walking in close proximity.

The leash system, according to an embodiment of the present invention, generally comprises a spring-loaded spool positioned at a central point on the leash and having at least two wires wound on the spool. The first wire can be attached to a first position proximate to the handle of the leash, while the end of the second wire can be attached to a second position proximate to the opposite end of the leash proximate to the animal. In this configuration, the spool is adapted to wind both wires onto the spool when no tension or a tension below a predetermined threshold is applied to the leash such that nearly the entirety of the leash can be folded into a loop or accordion shape. The central positioning of the spool allows for the effective length of the leash to be reduced to nearly zero when no tension or a tension below a predetermined threshold is applied to the leash.

In one aspect, the first position can be positioned at a location along the length of the leash to define a first portion of the leash that is not folded into a loop or accordion shape proximate to the leash handle. Similarly, the second position can be positioned at a location along the length of the leash to define a second portion of the leash that is not folded into a loop or accordion shape proximate to the end of the leash attached to the animal. The portion of the leash not folded by the leash system position the folded portions of the leash away from the user's hand or the animal to prevent tangling of either the user or the animal with the folded portion of the leash.

The leash system, according to an embodiment of the present invention, generally comprises a first clip assembly mounted to a fixed length leash at a first position, a second clip assembly mounted to the leash at the second position and a wire. The wire connects the first clip assembly and the second clip assembly to define a loop in the leash, wherein the effective length of the wire governs the size of the loop. When the effective length of the wire and correspondingly the distance between the first and second clip assemblies are at a minimum, the loop is at the maximum size absorbing the slack in the leash into the loop. In this position, the effective length of the leash is at a minimum reducing the amount of possible slack in the effective length of the leash. The first clip assembly can further comprise a spring mounted spool for receiving the wire. For the purpose of this description, the effective length of the wire is the length of the wire played out from the spool. Pulling on the leash to separate the first and second clip assembly draws wire from the spool to increase the effective length of the wire and compress the spring. At the same time, pulling the first and second clip assembly apart opens the loop until the leash is fully taut and the effective length of the leash is at a maximum. Removing the pull force on the leash by moving closer to the animal or vice versa allows the spring to rotate the spool and rewind the wire back onto the spool to reduce the effective length of the wire and reform the loop.

In one aspect, the leash system can comprise different types and lengths of fixed length leashes. Specifically, the leash system can be fitted to conventional leashes that have a fixed overall length. The slack control of the leash can be adjusted without changing the overall length of the leash by changing the position of the second clip assembly along the length of the leash, where the wire attaches to the leash, along the length of the leash to adjust the size of the loop or folded portion formed. The relative position of the attachment point of the wire along the length of the wire and corresponding size of the looped or folded portion changes the minimum effective length of the leash. Accordingly, a user can tailor the minimum effective of the leash to the size and ordinary behavior of the animal.

In operation, if the animal moves away from the person holding the leash, the increased tension on the leash pulls the first and second clip assemblies apart to extend the wire and reduce the size of the loop until the leash is fully taut and the effective leash length is maximized. Similarly, if the animal moves closer to the person, the reduced tension on the leash allows the spring to rewind the wire onto the spool to reform the loop and reduce the effective length of the leash reducing the likelihood that the animal will trip over or become entangled in the leash. According to an embodiment, the tensile strength of the wire is less than that of the leash as the leash is still the primary means of restraining the animal. The leash system is adapted to maintain a minimal amount of slack in the effective length of the leash, not to replace the strength of the leash in restraining the animal.

According to an embodiment, the leash can define a plurality of holes along the length of the leash. The wire can be threaded through the plurality of holes such that the portion of the leash that defines the loop is folded in an accordion like configuration when the first and second clip assemblies are pulled together. As the first and second clip assemblies are pulled apart, the loop unfolds to increase the effective length of the fixed length leash. In this configuration, the slack in the loop itself is controlled to prevent the animal or the user from being entangled in the looped portion of the leash. The approach allows the user to have increased flexibility in setting the overall effective length of the leash without having to compensate for a large loop section, which itself could become a safety hazard.

A method, according to an embodiment of the present invention, can comprise providing a fixed length leash and a leash system having a first clip assembly, a second clip assembly and a wire connecting the first and second clip assembly. The method further comprises affixing the first clip assembly to a first position along the leash and affixing the second clip assembly to a second position along the leash. The method also comprises winding the wire onto a spool mounted to the first clip assembly to reduce the effective length of the wire between the first and second clip assembly to form a loop in the leash and reduce the effective length of the leash, wherein tensioning the leash pulls wire from the spool to increase the effective length of the wire and open the loop until the leash is fully taut and the effective length of the leash is maximized. Finally, the method can further comprise releasing the tension on the leash to rewind the wire onto the spool to decrease the effective length of the wire and reform the loop.

The above summary of the various representative embodiments of the invention is not intended to describe each illustrated embodiment or every implementation of the invention. Rather, the embodiments are chosen and described so that others skilled in the art can appreciate and understand the principles and practices of the invention. The figures in the detailed description that follow more particularly exemplify these embodiments.

### BRIEF DESCRIPTION OF THE DRAWINGS

The invention can be completely understood in consideration of the following detailed description of various embodiments of the invention in connection with the accompanying drawings, in which:

FIG. 1 is a perspective view of a leash having a leash system according to an embodiment of the present invention attached.

FIG. 2 is a perspective view of the leash system depicted in FIG. 1.

FIG. 3 is a perspective view of a leash having a leash system according to an embodiment of the present invention, wherein the leash is tensioned to open the loop formed by the leash system.

FIG. 4 is a perspective view of the leash system depicted in FIG. 3.

FIG. 5 is a front view of a leash system according to an embodiment of the present invention.

FIG. 6 is a perspective view of the assembly of a second clip assembly of a leash system according to an embodiment of the present invention.

FIG. 7 is a front view of a pouch for receiving the spool according to an embodiment of the present invention.

FIG. 8 is a rear view of the pouch depicted in FIG. 7.

FIG. 9 is a perspective view of a leash having a leash system according to an embodiment of the present invention, wherein the looped portion of the leash is folded in an accordion shape.

FIG. 10 is an enlarged perspective view of the leash system depicted in FIG. 9.

FIG. 11 is an enlarged side view of the leash system depicted in FIG. 9.

FIG. 12 is a perspective view of the leash system depicted in FIG. 9, wherein the looped portion of the leash is partially extended.

FIG. 13 is a perspective view of a leash having a leash system according to an embodiment of the present invention, wherein the looped portion of the leash is folded in an accordion shape.

FIG. 14 is a perspective view of the leash system depicted in FIG. 13, wherein the looped portion of the leash is partially extended.

FIG. 15 is a perspective view of a friction mount according to an embodiment of the present invention.

FIG. 16 is a perspective view of a leash system according to an embodiment of the present invention.

FIG. 17 is a front view of the leash system depicted in FIG. 16.

FIG. 18 is a rear view of the leash system depicted in FIG. 16.

FIG. 19 is a top view of the leash system depicted in FIG. 16.

FIG. 20 is a side view of the leash system depicted in FIG. 16.

FIG. 21 is a bottom view of the leash system depicted in FIG. 16.

FIG. 22 is a side view of a leash system according to an embodiment of the present invention.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention as defined by the appended claims.

### DETAILED DESCRIPTION OF THE INVENTION

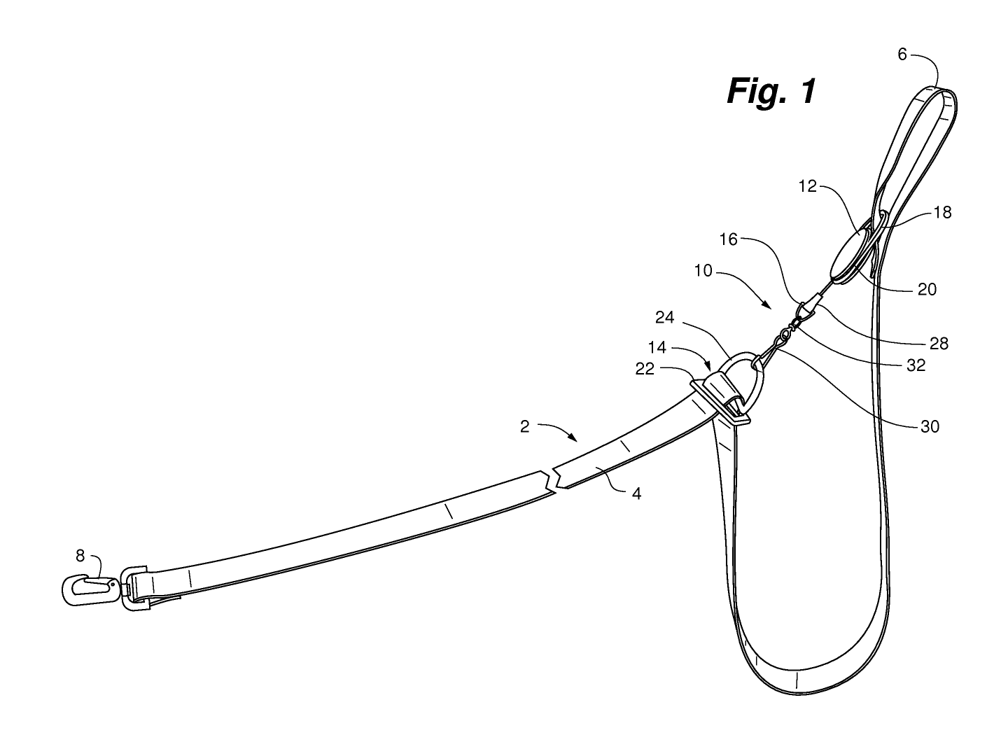

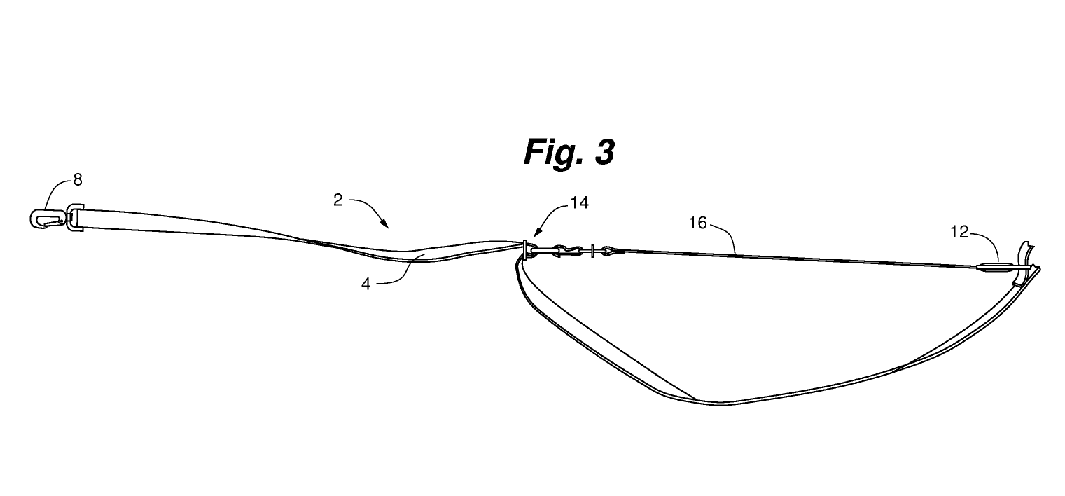

As depicted in FIGS. 1 and 3, a fixed length leash 2, for use with the present invention, generally comprises an elongated strap 4 having a handle 6 at one end of the strap 4 and an engagement means 8 at the other end of the strap 4. The effective length of the leash 2 is the portion of the leash 2 extending between the user and the animal generally along a single axis. The handle 6 can comprise a loop at the end of the strap 4 that can be gripped by a person. Similarly, the engagement means 8 can comprise a collar, a body or muzzle harness, or carabineer for clipping the strap 4 to a collar, body or muzzle harness.

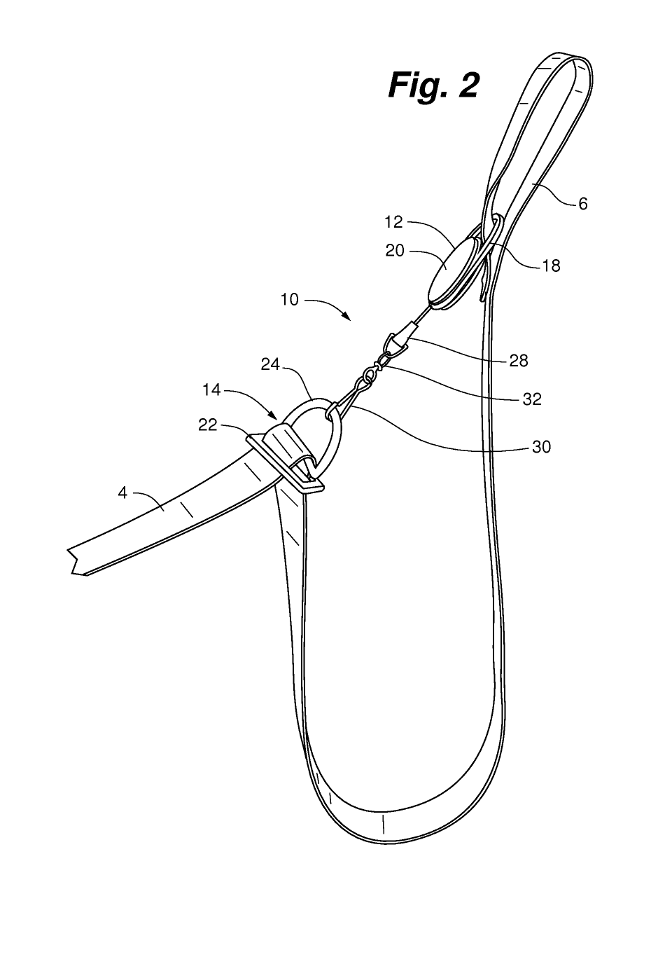

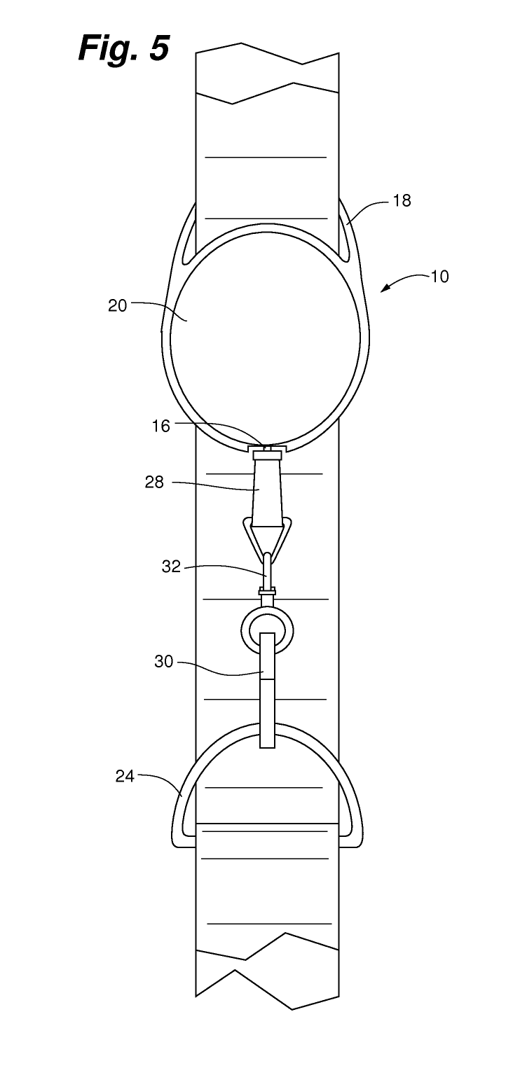

As depicted in FIGS. 1-5, the leash system 10, according to an embodiment, comprises a first clip assembly 12, a second clip assembly 14 and a wire 16. The first clip assembly 12 can further comprise a leash clip assembly 18 and spring-loaded spool 20. Similarly, the second clip assembly 14 can further comprise a leash clip assembly 22 and a wire clip 24. The wire 16 can further comprise a clip assembly 28 positioned at one end of the wire 16. The clip assembly 28 can comprise a releasable clip 30 and a rotating mechanism 32 for allowing the releasable clip 30 to rotate with the leash 2 if the leash 2 is twisted to prevent torquing of the wire 16.

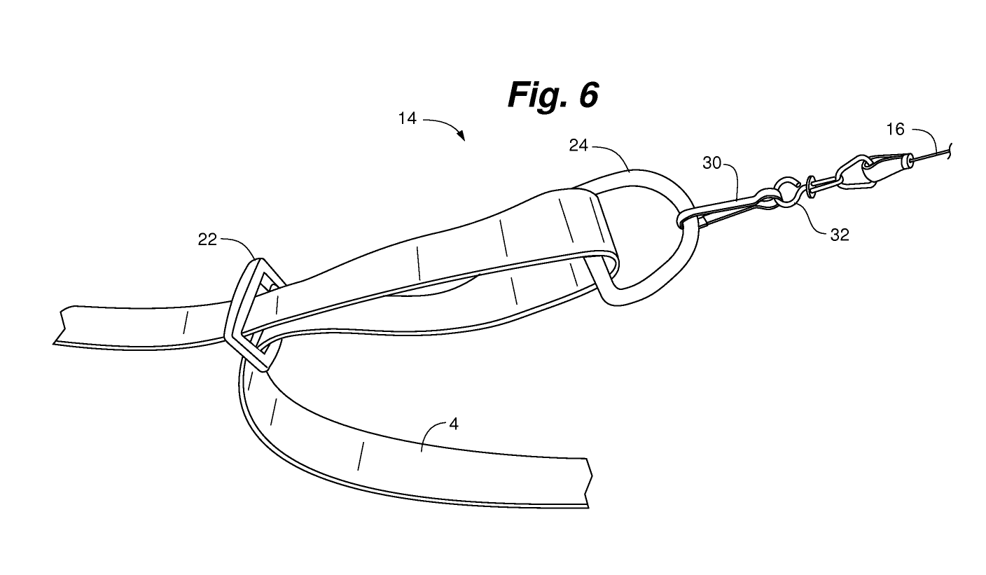

As depicted in FIGS. 1-5, the first clip assembly 12 is clipped to a first position on the leash 2. As depicted, the leash clip assembly 18 is a carabineer for clipping into the loop of the handle 6 at the end of the strap 4, but can comprise any conventional clip or conventional means for releasably mounting the first clip assembly 12 at a first position along the leash 2. When clipped to the handle 6, the leash clip assembly 18 can slide around the handle 6, but cannot slide down the leash 2. The second clip assembly 14 is mounted at a second position along the strap 4 of the leash 2. As depicted in FIG. 6, the leash clip assembly 22 comprises a rectangular ring 26 that is fit over a loop formed in the strap 4 of the leash 2. The wire clip 24 can then be fed through the loop and the rectangular ring 26 slid proximate to the wire clip 24 to fix the position of the wire clip 24 at a second position along the strap 4. The releasable clip 30 of the wire 16 is clipped to the wire clip 24 of the second clip assembly 14 to connect the first and second clip assemblies 12, 14 and form a loop in the strap 4. The distance between the first and second position on the leash 2 defines the length of the loop that is ultimately formed in the strap 4. The position of the second clip assembly 14 along the length of the strap 4 can be adjusted by the user to control the amount of slack in the effective portion of the strap 4 so as to accommodate for the height or the habits of the animal.

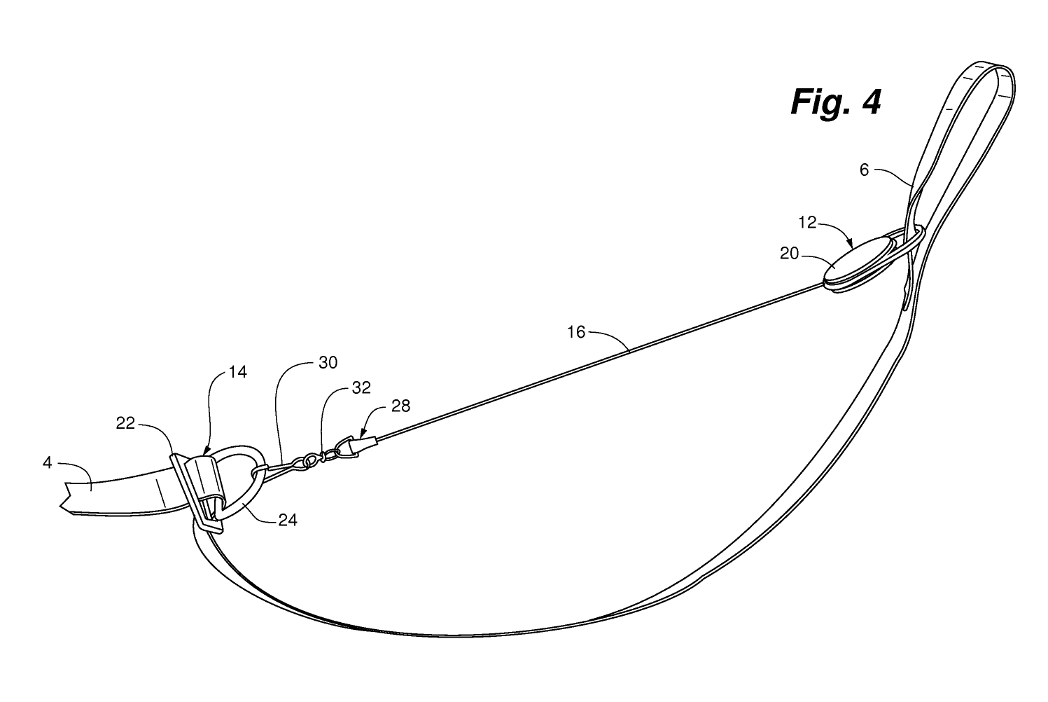

As depicted in FIGS. 3-4, the wire 16 is wrapped onto the spring-loaded spool 20 such that the wire 16 is played from the spool 20 when the leash 2 is tensioned by the movements of the animal or the person. The spool 20 is biased such that the wire 16 is wrapped onto the spool 20 when the leash 2 is not tensioned or tensioned less than a predetermined threshold such that the first and second clip assemblies 12, 14 pulled together and the size of the loop formed in the strap 4 is increased. During operation, the tensioning of the leash 2 draws wire 16 from the spool 20 and separates the first and second clip assemblies 12, 14 to open the loop defines in the strap 4 to increase the effective length of the leash 2. With a fixed length leash 2, the maximum effective length of the leash 2 corresponds to the overall length of the fixed length leash 2. Once the loop is fully open, the leash 2 bears the entirety of the pull force applied to the leash 2. After the tension is removed, the spool 20 rewinds the wire 16 to pull the first and second clip assemblies 12, 14 proximate to each other to reduce the effective length of the leash 2 and reform the loop in the strap 4.

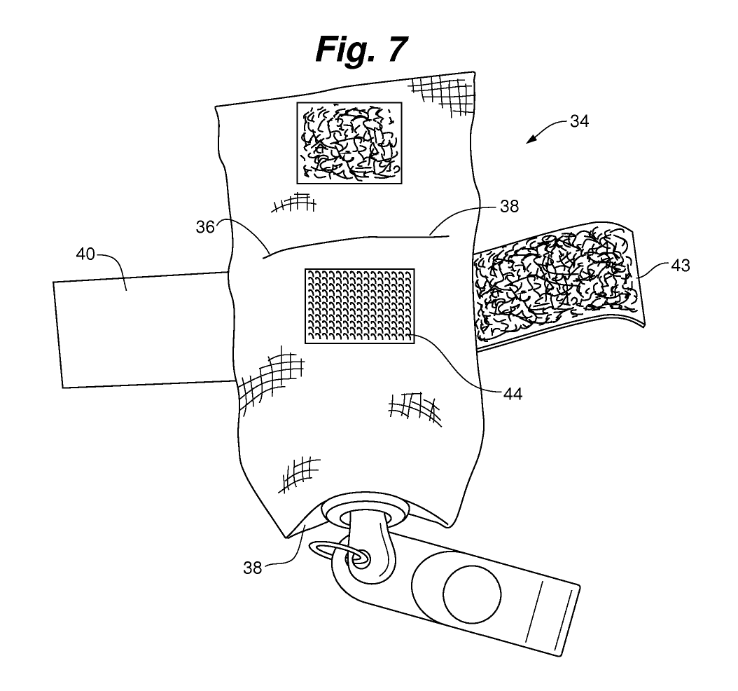

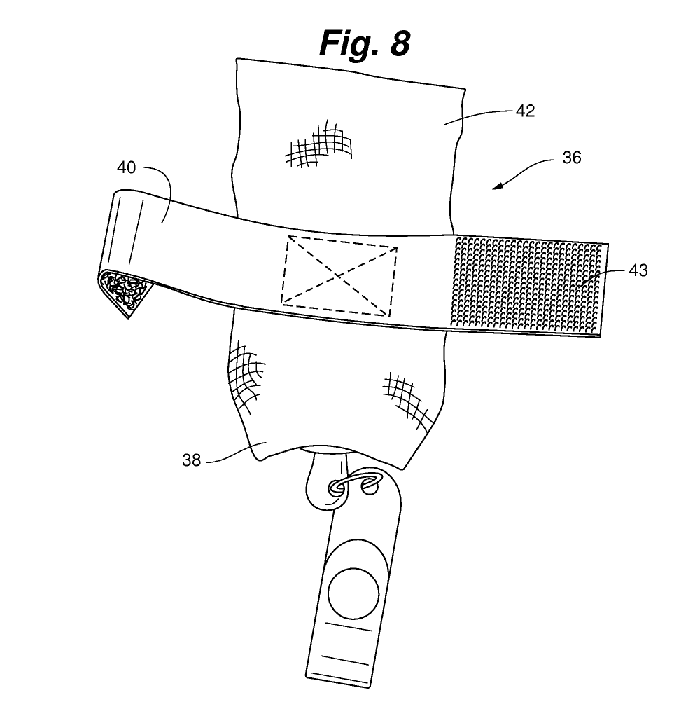

As depicted in FIGS. 7-8, according to an embodiment of the present invention, the first clip assembly 12 can alternatively comprise a pouch 34 for receiving the spool 20 instead of the leash clip assembly 18. The pouch 34 defines a cavity 36 for receiving the spool 20 and having at least two openings 38. The pouch 34 further comprises a leash strap 40 and a closeable flap 42 for covering one of the openings 38. The leash strap 40 can comprise a fastening means 43 such that the strap 40 can be releasably wrapped around the leash 2 at the first position along the leash 2. The fastening means 43 can comprise a Velcro strap, a button, or any other conventional releasable fastening means. Similarly, the closable flap 42 can comprise a fastening means 44 for retaining the spool 20 within the cavity 36. The fastening means 46 can comprise a Velcro strap, a button, or any other conventional releasable fastening means. In operation, the spool 20 is inserted into the cavity 36 such that the end of the wire 16 protrudes through one of the openings 38 in the pouch 34 and can be extended and refracted as in normal operation.

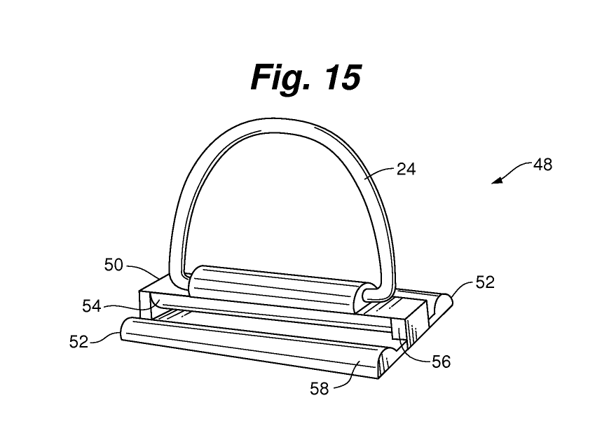

As depicted in FIG. 15, according to an embodiment of the present invention, the second clip assembly 14 can alternatively comprise a friction mount 48 that can be selectively positioned along the length of the leash 2. The friction mount 48 can comprise a loop portion 50 and two wing portions 52 positioned on either side of the loop portion 50. The loop portion 50 further comprises a rounded surface 54 positioned along the top of the loop portion 50 and a clip protrusion 56 at the end of the loop portion 50. Similarly, the wing portions 52 each comprise a rounded surface 58 positioned opposite the rounded surface 54 of the loop portion 50. In operation, a portion of the leash 2 is fed over the rounded surface 58 of one of the wing portion 52 and beneath the rounded surface 54 of the loop portion 50 before extending over the rounded surface 58 of the other wing portion 52. The rounded surfaces 54, 58 cooperated to define a bend in the leash 2 to help maintain the position of the friction mount 48 along the leash 2. The friction mount 48 can be fixed in place along the leash 2 by sliding a portion of the leash 2 beneath the clip protrusion 56 such that the portion of the leash 2 is pinched between the clip protrusion 56 and the wall of the loop portion 50. According to an embodiment, the wire clip 24 can be mounted to the friction mount 48 such that the wire 16 can be clipped to the second clip assembly 14.

According to an embodiment, the second clip assembly 14 can alternatively comprise a pin portion 60 affixable to the wire clip 24 and a pin fastener 62. In this configuration, the pin portion 60 can puncture the leash 2 and releasably locked in place by the pin fastener 62. The position of the second clip assembly 14 along the length of the leash 2 can be adjusted by removing the pin fastener 62 and puncturing the leash 2 at the new location.

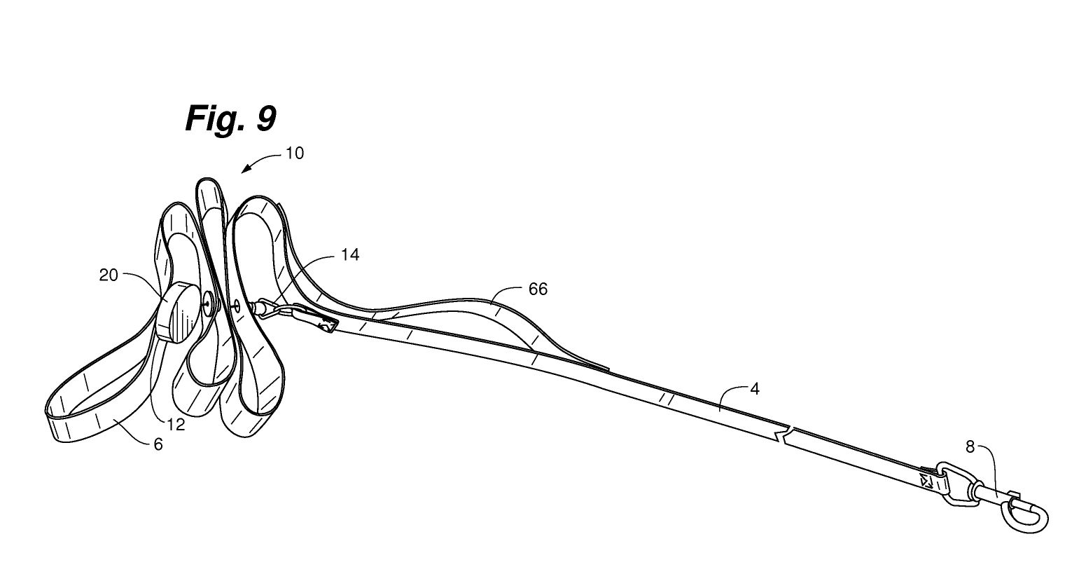

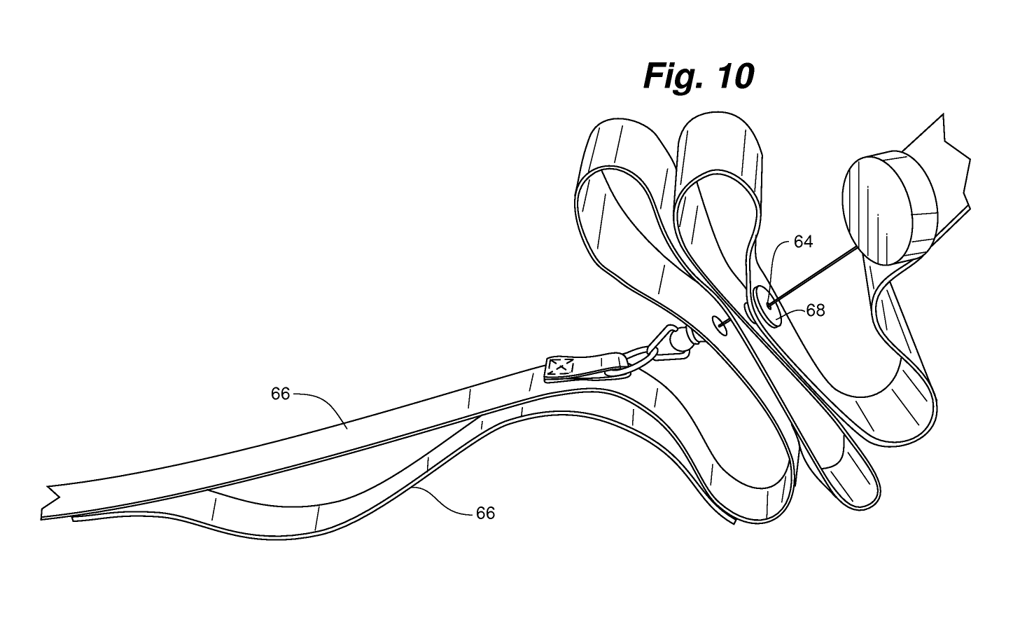

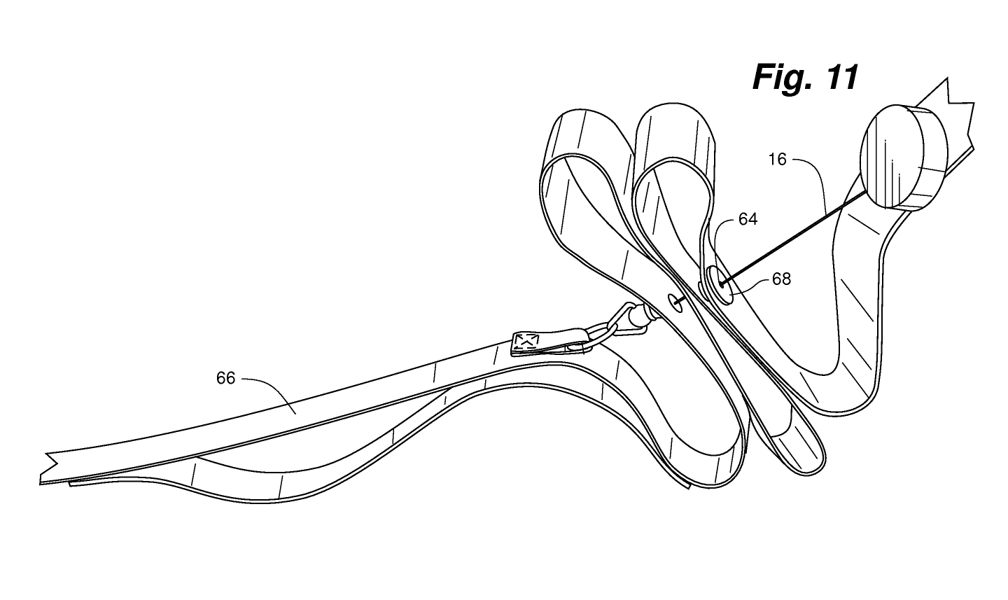

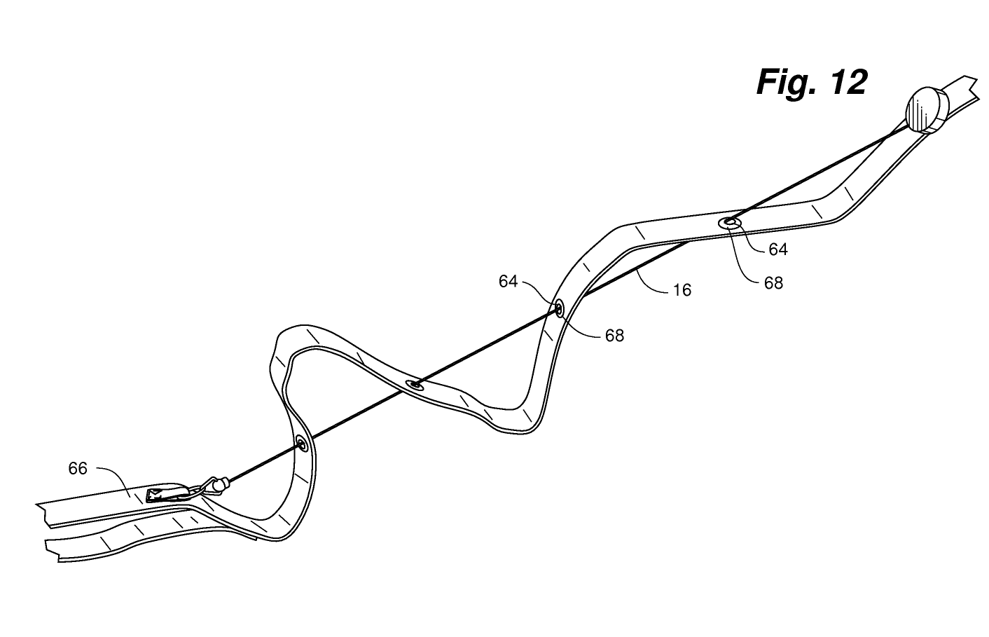

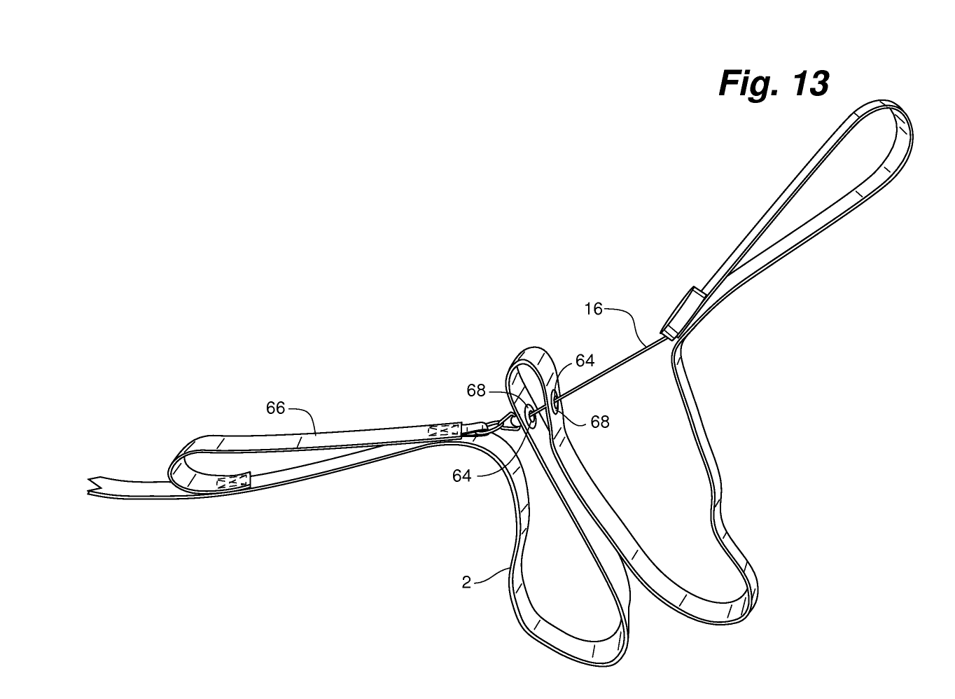

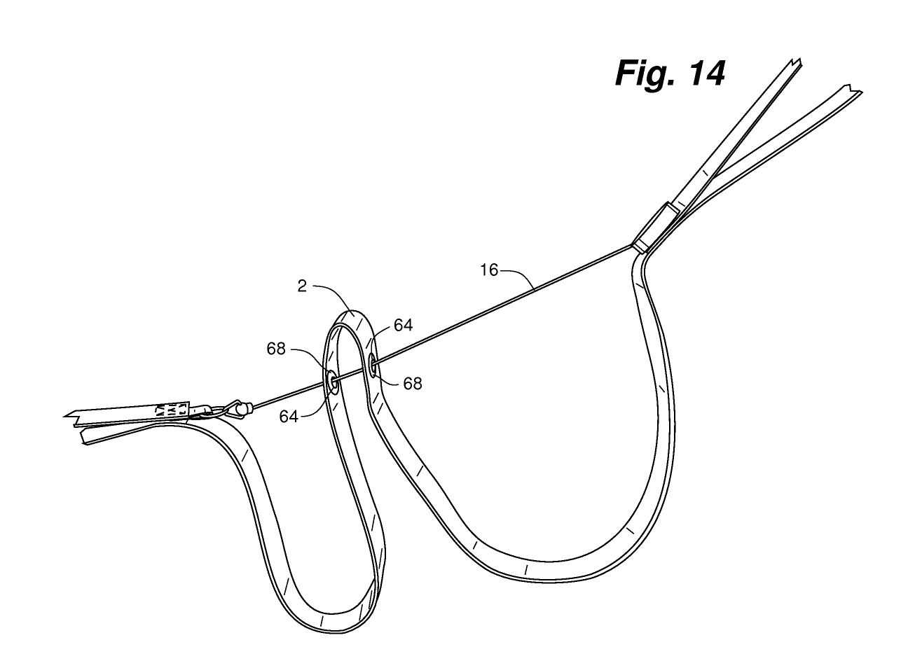

As depicted in FIGS. 9-14, according to an embodiment, the leash 2 can further define a plurality of holes 64 spaced along the length of the leash 2. The wire 16 can be threaded through the holes 64 such that the loop between the first and second clip assemblies 12, 14 is folded along the wire 16 in an accordion shape, rather than hanging beneath the wire 16 in an open loop. In operation, when the distance between the first and second assemblies 12, 14 is reduced, the loop formed in the leash 2 is tightly folded between the first and second assemblies 12, 14 thereby minimizing the effective length of the leash 2. As the first and second assemblies 12, 14 are pulled apart; the loop formed in the leash 2 unfolds increasing the effective length of the leash 2. The holes 64 can be evenly spaced along the length of the leash 2 such that the wire 16 intersects the center of the folds of the leash 2. Alternatively, the holes 64 can positioned in pairs such that the folds of the leash 2 hang beneath the wire 16. According to an embodiment, the leash 2 can further comprise a grommet 68 positioned around each of the holes 64 to prevent tearing of the holes 64.

As depicted in FIGS. 9-14, the leash 2 can further comprise a secondary handle 66 positioned in front of the secondary clip assembly 14. The secondary handle 66 can be gripped by the user to immediately restrain the animal at the minimum effective length rather than allow the animal to extend the leash to the maximum effective length. In addition, the secondary handle 66 and the handle 6 can both be gripped by the user to better restrain a larger animal.

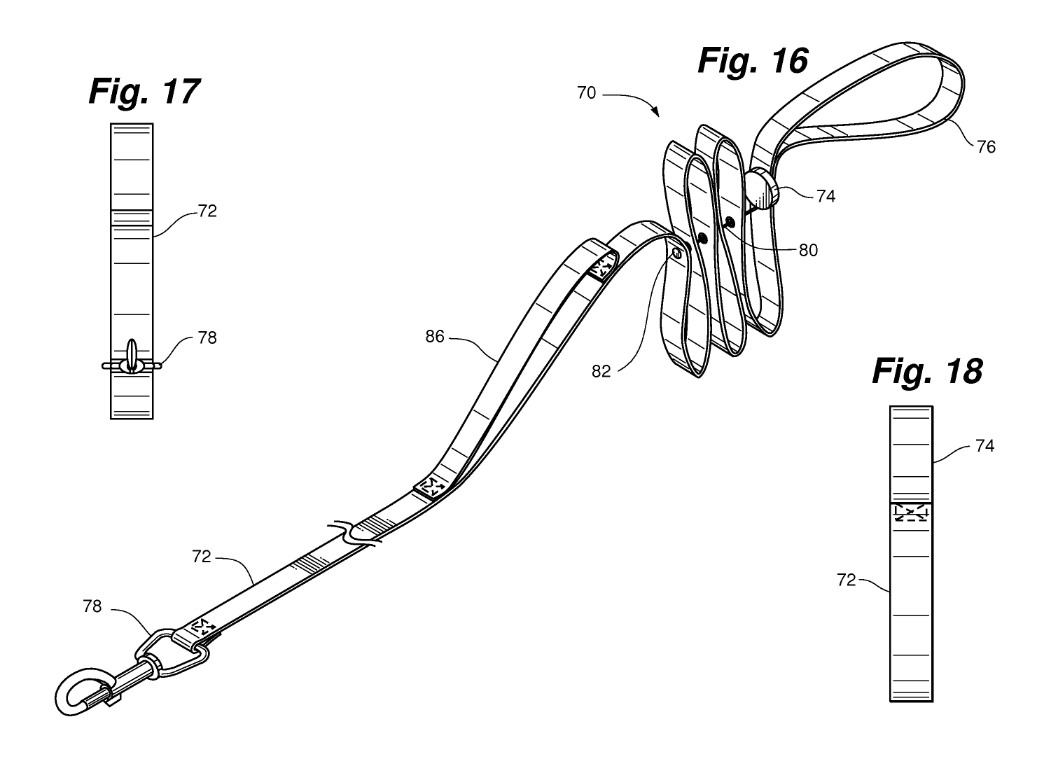

As depicted in FIGS. 16-21, a leash system 70, according to an embodiment of the present invention, comprises a leash 72 and a spool 74. The leash 72 further comprises a handle 76 at one end and an engagement mechanism 78 at the opposite end. The engagement mechanism 78 can be secured to a collar, halter or other conventional means of securing a leash 72 to an animal. The spool 74 is positioned proximate to the handle 76 and can further comprise a wire 80 affixed to a second position along the length of the leash 72. In one aspect, the leash 72 can further comprise a rivet 84 for securing the end of the wire 80 to the leash 72 at the second position.

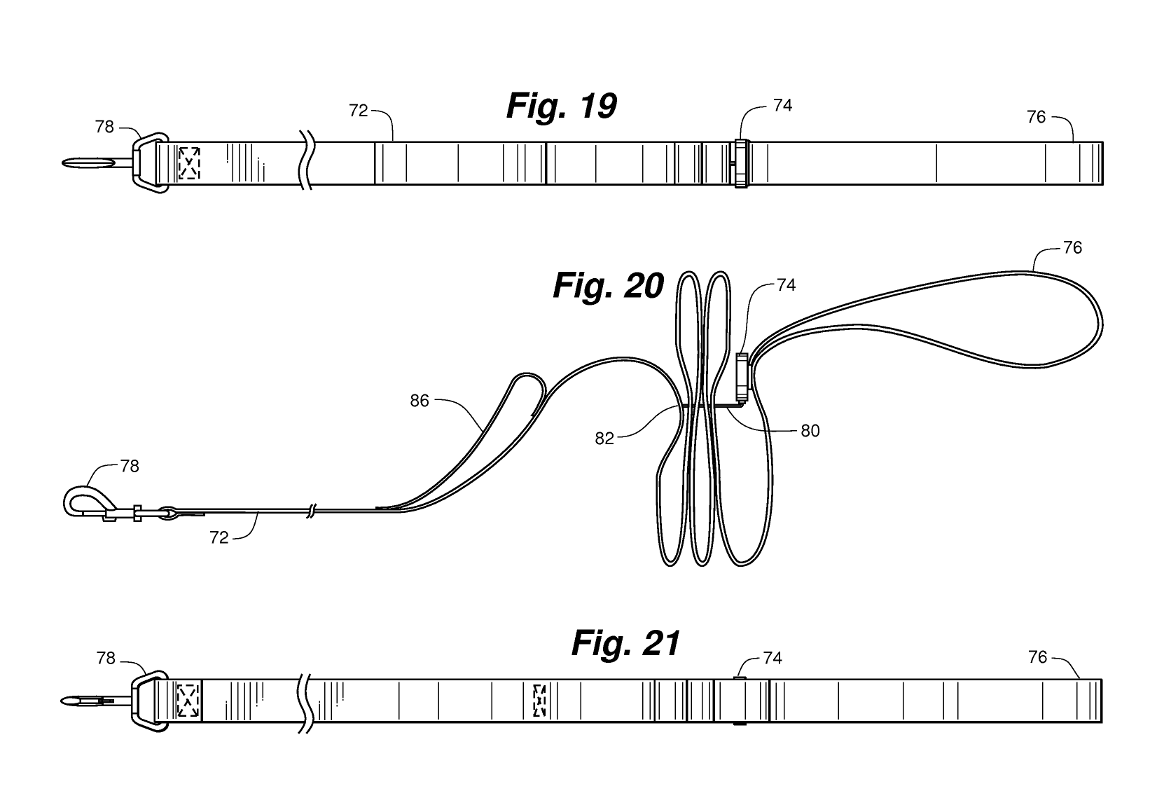

In operation, the spool 74 is spring-loaded to wind the wire 80 onto the spool 74 when the tension on the leash 72 is below a predetermined threshold, such as when the animal moves toward the user. In one aspect, the winding of the wire 80 onto the spool 74 forms the slacked portion of the leash 72 such that the portion of the leash 72 defining the effective length of the leash 72 remains taut. In another aspect, the leash 72 can further comprise a plurality of bore holes 82 through the leash 72. As depicted in FIGS. 16 and 20, in this configuration, the wire 80 is threaded through the leash 72 such that the slack portion of the leash 72 collapses into an accordion shape as the wire 80 is wound onto the spool 74. The leash 72 can further comprise a washer 84 in each of the bore holes 82 to prevent damage to the leash 72.

As depicted in FIGS. 16 and 20, in an embodiment of the present invention, the leash 72 can further comprise a secondary handle 86 at the second position on the leash 72. The secondary handle 86 allows the user to rapidly shorten the maximum effective length of the leash 72 if additional control over the animal is necessary.

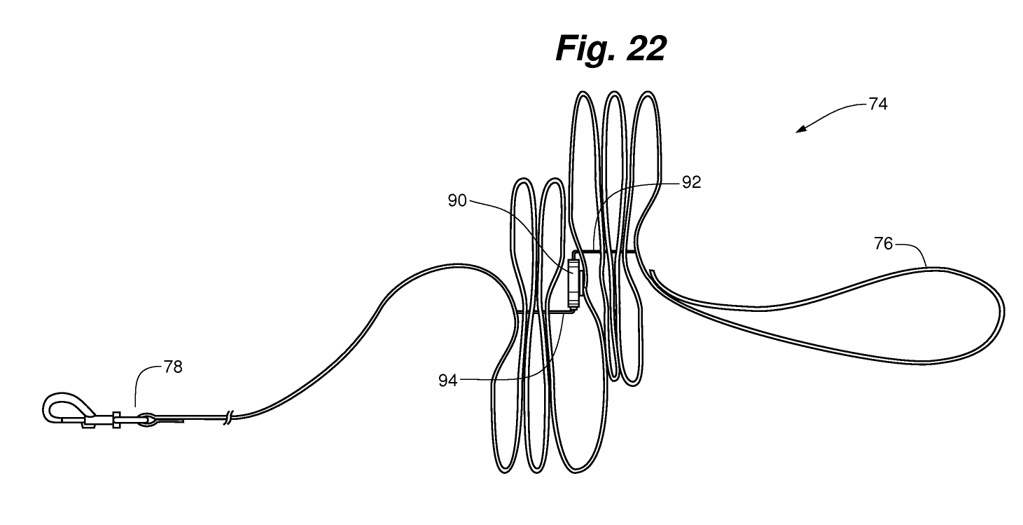

As depicted in FIG. 22, a leash system 88, according to an embodiment of the present invention, comprises the leash 72 and a spool 90. The spool 90 is positioned proximate to a central location along the length of the leash 72 and further comprises a first wire 92 and a second wire 94. The first wire 92 is securable to a position along the length of the leash 72 proximate to the handle 76 to define a first portion of the leash 72 that is folded into a loop or accordion shape when the first wire 92 is wound onto the spool 90. Similarly, the second wire 94 is securable to a position along the length of the leash 72 proximate to the engagement mechanism 78 of the leash 72 to define a second portion of the leash 72 that is folded into a loop or accordion shape when the second wire 94 is wound onto the spool 90. In one aspect, the maximum length of the first wire 92 and second wire 94 is each 1 m.

In operation, the spool 90 is spring-loaded to wind the first wire 92 and the second wire 94 onto the spool 90 when the tension on the leash 72 is below a predetermined threshold. Winding the first wire 92 and the second wire 94 onto the spool 90 creates the first and second folded portions of the leash 72, which are positioned on either side of the central location. In one aspect, the first and second positions can be moved inward from the ends of the leash 72 toward the central location. In this configuration, a portion of the leash proximate to either the handle 76 and/or the engagement mechanism 78 will not be folded when the first wire 92 and the second wire 94 is wound onto the spool 90. The unfolded portions act as a buffer between the folded portions of the leash 72 and the handle 76 and the engagement mechanism 78 to avoid tangling the user or animal in the folded portions of the leash 72.

While the invention is amenable to various modifications and alternative forms, specifics thereof have been shown by way of example in the drawings and described in detail. It is understood, however, that the intention is not to limit the invention to the particular embodiments described. On the contrary, the intention is to cover all modifications, equivalents, and alternatives falling within the spirit and scope of the invention as defined by the appended claims.

1. A leash system for controlling slack in a leash for restraining an animal, comprising:
a fixed length leash having a handle at a first end of the leash and an engagement mechanism at the second end of the leash, wherein the leash defines an effective length between the handle and the second end; and
a spring-loaded spool positioned on the leash at a first position on along the length of the leash and having a first wire wound onto the spool, wherein the first wire is affixed to the leash at a second position along the length of the leash;
wherein the spring-loaded spool is tensioned to spool out the first wire when tension exceeding a predetermined threshold is applied to the second end of the leash and wind the first wire onto the spool when the tension decreases below the predetermined threshold such that the length of the leash between the first and second positions is folded to reduce the effective length of the leash between the handle and the second end of the leash.

2. The leash system of claim 1, wherein the folded portion of the leash is folded into a loop.

3. The leash system of claim 1, wherein the leash defines a plurality of bore holes through which the first wire is threaded such that the folded portion of the leash is folded into an accordion shape.

4. The leash system of claim 3, wherein the leash further comprises a washer positioned within each of the bore holes.

5. The leash system of claim 1, wherein the leash further comprises a secondary handle at the second position along the length of the leash.

6. The leash system of claim 1, wherein the first position is proximate to the handle and the second position is proximate to the engagement mechanism.

7. The leash system of claim 1, wherein the spool further comprises a second wire affixed to the leash at a third position along the length of the leash;
wherein the spring-loaded spool is tensioned to spool out the second wire when tension exceeding a predetermined threshold is applied to the second end of the leash and wind the second wire onto the spool when the tension decreases below the predetermined threshold such that the length of the leash between the first and third positions is folded to reduce the effective length of the leash between the handle and the second end of the leash.

8. The leash system of claim 7, wherein the first position is proximate to the center of the leash, the second position is proximate to the engagement mechanism, and the third position is proximate to the handle.

9. A leash system for controlling slack in a fixed length leash having a handle at one end and an engagement mechanism at the second end of the leash, comprising:
a first clip assembly having a spring-loaded spool and a first leash clip assembly for securing the first clip assembly to the leash at the handle;
a second clip assembly a second leash clip assembly for securing the second clip assembly to the leash at a second position along a length of the leash; and
a wire connecting the first clip assembly to the second clip assembly, wherein the spring-loaded spool is adapted to wind the wire onto the spring-loaded spool when the tension applied to the second end of the leash decreases below a predetermined threshold such that a portion of the leash is folded to reduce the effective length of the leash between the handle and the second end of the leash; wherein the spool is adapted to play out the wire when the tension applied to the second end is exceeds than the predetermined threshold to unfold the folded portion of the leash to increase the effective length of the leash.

10. The leash system of claim 9, wherein the folded portion of the leash is folded into a loop.

11. The leash system of claim 9, wherein the leash defines a plurality of bore holes through which the wire is threaded such that the folded portion of the leash is folded into an accordion shape.

12. The leash system of claim 11, wherein the leash further comprises a washer positioned within each of the bore holes.

13. The leash system of claim 9, wherein the leash further comprises a secondary handle at the second position along the length of the leash.

14. A method of controlling slack in a fixed length leash having a handle at one end of the leash and an engagement mechanism at the second end of the leash, comprising:
positioning a spring-loaded spool on the leash at a first position along a length of the leash; providing a first wire windable onto the spool;
attaching an end of the first wire to a second position along the length of the leash;
winding a portion of the first wire onto the spool when the tension applied to the second end of the leash is less than a predetermined threshold to move the second position proximate to the spool; and
unwinding a portion of the first wire from the spool when the tension applied to the second end of the leash is greater than the predetermined threshold to move the second position away from the spool.

15. The method of claim 14, wherein moving the second position of the leash proximate to the spool folds a portion of the leash into a loop to reduce the effective length of the leash, wherein unwinding a portion of the first wire from the spool opens the folded portion of the leash to increase the effective length of the leash.

16. The method of claim 14, further comprising changing the second position of the leash to alter the portion of the leash folded into the loop when the second position of the leash is moved proximate to the spool.

17. The method of claim 14, wherein the leash defines a plurality of bore holes spaced along a portion of the leash.

18. The method of claim 17, further comprising threading the first wire through the plurality of bore holes such that moving the second position of the leash proximate to the spool folds a portion of the leash in an accordion shape.

19. The method of claim 18, further comprising changing the second position of the leash to alter the portion of the leash folded into the loop when the second position of the leash is moved proximate to the spool.

20. The method of claim 14, further comprising providing a second wire windable onto the spool;
attaching an end of the second wire to a third position along the length of the leash;
winding a portion of the second wire onto the spool when the tension applied to the second end of the leash is less than a predetermined threshold to move the third position proximate to the spool; and
unwinding a portion of the second wire from the spool when the tension applied to the second end of the leash is greater than the predetermined threshold to move the third position away from the spool.

21. A leash system for controlling slack in a leash for restraining an animal, comprising:
a fixed length leash having a handle at a first end of the leash and an engagement mechanism at the second end of the leash, wherein the leash defines an effective length between the handle and the second end; and
a spring-loaded spool positioned on the leash at a central position on along the length of the leash and having a first wire and a second wire wound onto the spool, wherein the first wire is affixed to the leash at a first position along the length of the leash and the second wire is affixed to the leash at a second position along the length of the leash;
wherein the spring-loaded spool is tensioned to spool out the first and second wires when tension exceeding a predetermined threshold is applied to the second end of the leash and wind the first and second wires onto the spool when the tension decreases below the predetermined threshold such that the length of the leash between the first position and the central position and the length of the leash between the second position and the central position are folded to reduce the effective length of the leash between the handle and the second end of the leash.

22. The leash system of claim 21, wherein the folded portions of the leash are folded into loops.

23. The leash system of claim 21, wherein the leash defines a plurality of bore holes through which the first and second wires are threaded such that the folded portions of the leash are folded into an accordion shape.

24. The leash system of claim 23, wherein the leash further comprises a washer positioned within each of the bore holes.

25. The leash system of claim 21, wherein the leash further comprises a secondary handle at the second position along the length of the leash.

26. The leash system of claim 21, wherein the first position is proximate to the handle and the second position is proximate to the engagement mechanism.
